(19) United States
(12) Patent Application Publication
(10) Pub. No.: US 2021/0325723 A1
(43) Pub. Date: Oct. 21, 2021

(54) COLOR FILTER SUBSTRATE AND FABRICATION METHOD THEREOF

(71) Applicant: TCL CHINA STAR OPTOELECTRONICS TECHNOLOGY CO., LTD., Shenzhen, Guangdong (CN)

(72) Inventor: Yuxin PAN, Shenzhen (CN)

(21) Appl. No.: 16/618,923

(22) PCT Filed: Sep. 11, 2019
(86) PCT No.: PCT/CN2019/105338

§ 371 Date: Dec. 3, 2019

(30) Foreign Application Priority Data
May 24, 2019 (CN) 201910440219.6

(51) Int. Cl. G02F 1/1335; G02F 1/1339

(52) U.S. Cl. CPC G02F 1/133516; G02F 1/133512; G02F 1/13394

(57) ABSTRACT

A color filter substrate, adapted to a liquid crystal display panel, includes a transparent substrate layer, a black matrix layer, a color filter layer, an electrically conductive layer, and a spacer layer. The black matrix layer is disposed on the transparent substrate layer and includes a plurality of hollow areas spaced apart from each other. The color filter layer includes a plurality of color resists spaced apart and covering the hollow areas of the black matrix layer, respectively. A gap is disposed between adjacent two of the color resists. The electrically conductive layer is disposed on the color filter layer. The spacer layer includes a plurality of spacers. A part of each of the spacers is disposed in the gap of the color filter layer, and another part is overlappingly disposed on the electrically conductive layer corresponding to the color resists.

### BACKGROUND OF INVENTION

### 1. Field of Invention

The present invention relates to a technical field of displays, and particularly to, a color filter substrate and a fabrication method thereof.

### 2. Related Art

In fabricating processes of liquid crystal display panels, a plurality of post spacers (PS) are formed on surfaces of color filter substrates facing array substrates to separate the color filter substrates from the array substrates for cell-assembly and for filling of liquid crystal, thereby to complete fabrication of the liquid crystal displays.

The post spacers each are in contact with the array substrates and the color filter substrates to support the array substrates and the color filter substrates, so that a space is formed between the array substrate and the color filter substrates for filling liquid crystal therein. However, when surfaces of conventional liquid crystal display panels are pressed by an external force, photo spacers between the array substrates and the color filter substrates may move by the external force, causing the post spacers to be displaced from preset positions. As light emitted by backlights hits liquid crystal displays, since positions of the post spacers are different from the preset positions, streaks may appear on surfaces of the liquid crystal displays, adversely affecting display effects.

### SUMMARY OF INVENTION

An object of the present application is to provide a color filter substrate configured with a spacer structure not prone to displacement or disengagement for being firmly held on a corresponding array substrate and for facilitating formation of a space of placing a liquid crystal layer.

To achieve the above-mentioned object, the present application provides a color filter substrate, adapted to a liquid crystal display panel, the color filter substrate comprising transparent substrate layer; a black matrix layer disposed on the transparent substrate layer and comprising a plurality of hollow areas spaced apart from each other; a color filter layer comprising a plurality of color resists spaced apart from each other and covering the hollow areas of the black matrix layer, respectively, wherein a gap is disposed between adjacent two of the color resists; an electrically conductive layer disposed on the color filter layer; and a spacer layer comprising a plurality of spacers, wherein a part of each of the spacers is disposed in the gap of the color filter layer, and another part is overlappingly disposed on the electrically conductive layer corresponding to the color resists.

The present application further provides a method of fabricating a color filter substrate, comprising forming a black matrix layer on a transparent substrate layer, and forming, by a photolithography process, a plurality of hollow areas spaced apart from each other on the black matrix layer; forming a color filter layer on the transparent substrate layer, wherein the color filter layer comprises a plurality of color resists spaced apart from each other and covering the hollow areas of the black matrix layer, respectively, wherein a gap is disposed between adjacent two of the color resists; forming an electrically conductive layer on the color filter layer; coating a photoresist layer on the transparent substrate layer to allow part of the photoresist layer to be filled in the gaps of the color filter layer, and another part of the photoresist layer to cover the electrically conductive layer on the color resists; and forming, by a photolithography process including exposure and development and a baking process, the photoresist layer into a plurality of spacers, wherein a part of each of the spacers is filled up in the gap, and another part is overlapping disposed on the electrically conductive layer corresponding to the color resists.

The present application further provides a color filter substrate, adapted to a liquid crystal display panel, the color filter substrate comprising a transparent substrate layer; a black matrix layer disposed on the transparent substrate layer, wherein the black matrix comprises a plurality of photoresist strips disposed in an intersecting arrangement, and a plurality of hollow areas disposed among the photoresist strips; a color filter layer comprising a plurality of color resists spaced apart from each other and covering the hollow areas of the black matrix layer, respectively, wherein a gap is disposed between adjacent two of the color resists; an electrically conductive layer disposed on the color filter layer; and a spacer layer comprising a plurality of spacers, wherein a part of each of the spacers is disposed in the gap of the color filter layer, and another part is overlappingly disposed on the electrically conductive layer corresponding to the color resists; wherein each of the spacers comprises a root portion and an exposed portion, wherein the root portion is filled up in the gap, the exposed portion is exposed to the gap and is overlappingly disposed on the electrically conductive layer corresponding to the color resists, and a surface of the exposed portion adjoining the electrically conductive layer has a width greater than that of a side of the exposed portion away from the electrically conductive layer.

In another embodiment of the present application, a total area of the lip portion of each of the color resists overlapping the photoresist strips is less than a width of a corresponding photoresist strip in cross section.

In another embodiment of the present application, the lip portion of each of the color resists is disposed along a periphery of the color resist, and the gap disposed between the adjacent two of the color resists has a width of 5-40 microns.

In another embodiment of the present application, the lip portions of the color resists are fabricated by a halftone mask, and the lip portions each have an inclined edge or a curved edge.

In another embodiment of the present application, each of the spacers comprises a root portion and an exposed portion, wherein the root portion is filled up in the gap, the exposed portion is exposed to the gap and is overlappingly disposed on the electrically conductive layer corresponding to the color resists, and a surface of the exposed portion adjoining the electrically conductive layer has a width greater than that of a side of the exposed portion away from the electrically conductive layer.

Based on the color filter substrate and the method of fabricating the color filter substrate, the gap between the color resists is configured to allow the spacer to be firmly fixed to the corresponding gap on the black matrix layer. Furthermore, the exposed portion of the spacer extending outward is configured to overlap the color resists to further increase a contact area between the spacer and the electrically conductive layer on the corresponding color resists, thereby enhancing an attaching force. Furthermore, structural strength of the color filter substrate in a transverse direction can be greatly improved by a structure overlapped by the lip portions of the color resists and the black matrix layer, and structural strength of the black matrix layer in a longitudinal direction can further be strengthened. Therefore, based on the structure of the spacer and the color resists, the color filter substrate of the present application can be effectively prevented from causing the spacer to be displaced by an external force, thereby avoiding displacement of the color filter substrate, improving display effects, and overcoming the problem of poor display quality resulted from a structure that conventional spacers cannot be firmly held on array substrates.

### BRIEF DESCRIPTION OF DRAWINGS

FIG. 1 is a schematic plan view of a color filter substrate of an embodiment of the present application.

FIG. 2 is a schematic partial structural view of the color filter substrate of the embodiment of the present application.

FIG. 3 is another schematic partial structural view of the color filter substrate of the embodiment of the present application.

FIG. 3A is a schematic structural view of the color filer substrate of FIG. 3.

FIG. 4 is another schematic partial structural view of the color filter substrate of the embodiment of the present application.

FIG. 5 is a schematic cross-sectional view of the color filter substrate of the embodiment of the present application.

FIG. 6 is a schematic cross-sectional view of a color filter substrate of another embodiment of the present application.

FIG. 7 is a flowchart of a method of fabricating a color filter substrate of the present application.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

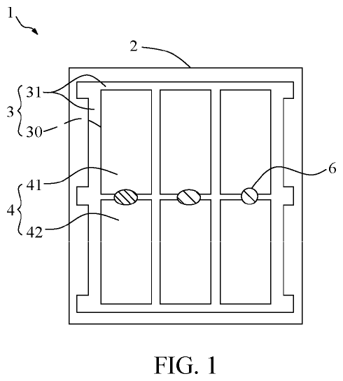

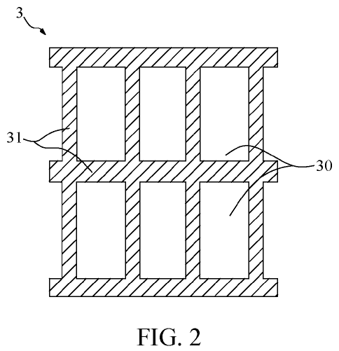

The present application discloses a color filter substrate adapted to a liquid crystal display (LCD) panel, wherein the LCD panel includes a plurality of pixel units. Each of the pixel units has a general pixel unit structure, that is, each pixel unit includes a red sub-pixel, a green sub-pixel, and a blue sub-pixel. FIG. 1 is a schematic plan view of a color filter substrate of an embodiment of the present application. FIGS. 2 to 4 are each a schematic partial structural view of the color filter substrate of the embodiment of the present application and can be referred to as description of manufacturing processes of the color filter substrate of the present application. As shown in FIG. 1, the color filter substrate 1 of the present application includes a transparent substrate layer 2, a black matrix layer 3, a color filter layer 4, an electrically conductive layer 5, and a spacer layer 6. The transparent substrate layer 2 is made of a glass material and is disposed corresponding to an array substrate (not shown) of the liquid crystal display panel.

Please refer to FIG. 2 in combination with FIG. 1. The black matrix layer 3 is disposed on the substrate layer 2 and includes a plurality of hollow areas 30 spaced apart from each other. Specifically, the black matrix layer 3 includes a plurality of photoresist strips 31 made of a photoresist material and disposed in an intersecting arrangement. That is, the photoresist strips 31 are longitudinally and transversely intersected with each other, so that the plurality of hollow areas 30 are each surrounded by the photoresist strips 31 and disposed corresponding to sub-pixels.

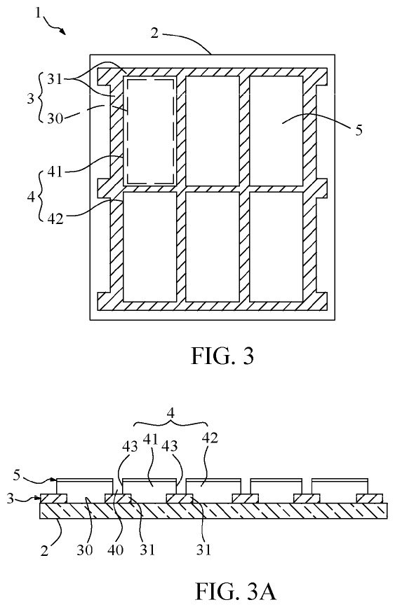

Please refer to FIG. 3 and FIG. 3A, wherein FIG. 3A is a schematic structural view of the color filer substrate of FIG. 3. As shown in FIG. 3, the color filter layer 4 includes a plurality of color resists 41 and 42 spaced apart from each other and made of a transparent material. The color resists 41 and 42 cover the hollow areas 30 of the black matrix layer 3, respectively. The color resists 41 and 42 include red, green, and blue color resists configured to allow light emitted from a backlight module (not shown) of the liquid crystal display to present a corresponding color through the color filter layer 4. Particularly, each of the color resists 41 and 42 has an area greater than that of each of the hollow areas 30, so that a gap 40 is disposed between adjacent two of the color resists 41 and 42 (as shown in FIG. 3A). That is, peripheries of each of the color resists 41 and peripheries of each of the color resists 42 are separated by the gaps 40. As shown in FIG. 3A, each of the color resists 41 and 42 has a lip portion 43 overlappingly disposed on the photoresist strips 31 of the black matrix layer 3. Specifically, a total area of the lip portion 43 of each of the color resists 41 overlapping the photoresist strips 31 is less than a width of a corresponding photoresist strip 31 in cross section. Namely, a total area (i.e. lip portion 43) of the color resist 41 and the next color resist 42 overlap a same photoresist strip 31 is less than the width of the photoresist strip 31 in cross section. In this embodiment, the lip portion 43 of each of the color resists 41 and 42 is disposed along peripheries of the color resists 41 and 42, and the gap 40 disposed between the adjacent two of the color resists 41 and 42 has a width of 5-40 microns.

Please continue referring to FIG. 3A. After forming the color filter layer 4, the electrically conductive layer 5 made of indium tin oxide is further formed on the color filter layer 4 and functions as a metal electrode from which a voltage is applied to liquid crystal molecules.

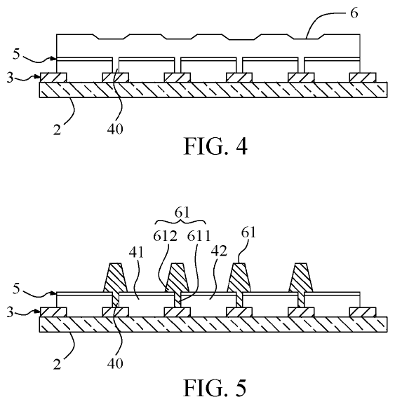

Please refer to FIGS. 4 and 5. The color filter substrate 1 of the present application is further coated with a photoresist layer on the transparent substrate layer 2 to form the spacer layer 6 (as shown in FIG. 4), wherein the spacer layer 6 is formed into a plurality of spacers 61 through a photolithography process and a baking process (as shown in FIG. 5). A part of each of the spacers 61 is disposed in the gap 40 of the color filter layer 4, and another part is overlappingly disposed on the electrically conductive layer 5 corresponding to the color resists 41 and 42. Specifically, each of the spacers 61 includes a root portion 611 and an exposed portion 612, wherein the root portion 611 is filled up in the gap 40, the exposed portion 612 is exposed to the gap 40 and is overlappingly disposed on the electrically conductive layer 5 corresponding to the color resists 41 and 42. In this embodiment, a surface of the exposed portion 612 adjoining the electrically conductive layer 5 has a width greater than that of a side of the exposed portion 612 away from the electrically conductive layer 5. That is, a radial width of the exposed portion 612 of the spacer 61 gradually increases outwardly of the root exposed portion 612, so that the exposed portion 612 is substantially conical in shape.

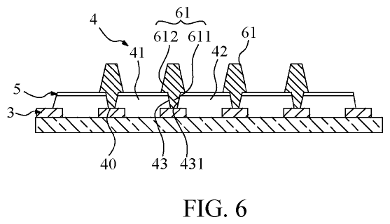

FIG. 6 is a schematic cross-sectional view of a color filter substrate of another embodiment of the present application. FIG. 6 illustrates another structure of the color filter layer 4 and the spacer layer 6 of the present application. In this embodiment, the lip portions 43 of the color resists 41 and 42 are fabricated by a halftone mask to determine a thickness of where the color resists 41 and 42 overlap the black matrix 3, that is, a thickness of the lip portion 43. In this embodiment, the lip portions 43 each have an inclined edge 431 or a curved edge, wherein the root portions 611 of the spacers 61 are formed to correspond to a shape of the lip portions 43, and are filled up in the gaps 40, respectively. In this manner, a contact area between the root portion 611 and the color resists 41 and 42 is increased, thereby to firmly fix the spacer 61 to the gap 40.

As described above, the color filter substrate 1 of the present application utilizes the gap 40 between the color resists 41 and 42 to allow the spacer 61 to be firmly fixed to the corresponding gap 40 on the black matrix layer 3 and to be held on a corresponding array substrate. Furthermore, edges of the spacer 61 extend outward to overlap the color resists 41 and 42 to further increase a contact area between the spacer 61 and the electrically conductive layer 5 on the corresponding color resists 41 and 42, thereby enhancing an attaching force so that displacement of the spacer 61 can be prevented from being affected by an external force.

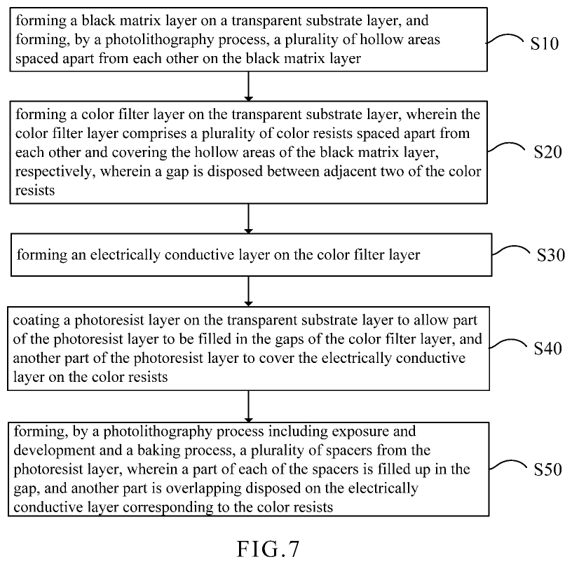

FIG. 7 is a flowchart of a method of fabricating a color filter substrate of the present application. The present application further provides a method of fabricating a color filter substrate, including steps S10-S60 as follows:

S10: forming a black matrix layer on a transparent substrate layer, and forming a plurality of hollow areas spaced apart from each other on the black matrix layer by a photolithography process.

S20: forming a color filter layer on the transparent substrate layer, wherein the color filter layer includes a plurality of color resists spaced apart from each other and covering the hollow areas of the black matrix layer, respectively, wherein a gap is disposed between adjacent two of the color resists.

S30: forming an electrically conductive layer on the color filter layer.

S40: coating a photoresist layer on the transparent substrate layer to allow part of the photoresist layer to be filled in the gaps of the color filter layer, and another part of the photoresist layer to cover the electrically conductive layer on the color resists.

S50: forming the photoresist layer into a plurality of spacers by a photolithography process including exposure and development and a baking process, wherein a part of each of the spacers is filled up in the gap, and another part is overlapping disposed on the electrically conductive layer corresponding to the color resists.

In the method for fabricating the color filter substrate of the present application, the detailed structural elements of the color filter substrate are the same as those of the color filter substrate described in the foregoing embodiments, and will not be repeated herein.

Based on the color filter substrate and the method of fabricating the color filter substrate, the gap between the color resists is configured to allow the spacer to be firmly fixed to the corresponding gap on the black matrix layer. Furthermore, the exposed portion of the spacer extending outward is configured to overlap the color resists to further increase a contact area between the spacer and the electrically conductive layer on the corresponding color resists, thereby enhancing an attaching force. Furthermore, structural strength of the color filter substrate in a transverse direction can be greatly improved by a structure overlapped by the lip portions of the color resists and the black matrix layer, and structural strength of the black matrix layer in a longitudinal direction can further be strengthened. Therefore, based on the structure of the spacer and the color resists, the color filter substrate of the present application can be effectively prevented from causing the spacer to be displaced by an external force, thereby avoiding displacement of the color filter substrate, improving display effects, and overcoming the problem of poor display quality resulted from a structure that conventional spacers cannot be firmly held on array substrates.

Accordingly, although the present invention has been disclosed as a preferred embodiment, it is not intended to limit the present invention. Those skilled in the art without departing from the spirit and scope of the present invention may make various changes or modifications, and thus the scope of the present invention should be after the appended claims and their equivalents.

What is claimed is:

1. A color filter substrate, adapted to a liquid crystal display panel, the color filter substrate comprising:
a transparent substrate layer;
a black matrix layer disposed on the transparent substrate layer and comprising a plurality of hollow areas spaced apart from each other;
a color filter layer comprising a plurality of color resists spaced apart from each other and covering the hollow areas of the black matrix layer, respectively, wherein a gap is disposed between adjacent two of the color resists;
an electrically conductive layer disposed on the color filter layer; and
a spacer layer comprising a plurality of spacers, wherein a part of each of the spacers is disposed in the gap of the color filter layer, and another part is overlappingly disposed on the electrically conductive layer corresponding to the color resists.

2. The color filter substrate of claim 1, wherein the black matrix layer comprises a plurality of photoresist strips disposed in an intersecting arrangement, wherein the plurality of hollow areas are each surrounded by the photoresist strips, and wherein each of the color resists comprises a lip portion overlappingly disposed on the photoresist strips of the black matrix layer.

3. The color filter substrate of claim 2, wherein a total area of the lip portion of each of the color resists overlapping the photoresist strips is less than a width of a corresponding photoresist strip in cross section.

4. The color filter substrate of claim 2, wherein the lip portion of each of the color resists is disposed along a periphery of the color resist, and the gap disposed between the adjacent two of the color resists has a width of 5-40 microns.

5. The color filter substrate of claim 2, wherein the lip portions of the color resists are fabricated by a halftone mask, and the lip portions each have an inclined edge or a curved edge.

6. The color filter substrate of claim 1, wherein each of the spacers comprises a root portion and an exposed portion, wherein the root portion is filled up in the gap, the exposed portion is exposed to the gap and is overlappingly disposed on the electrically conductive layer corresponding to the color resists, and a surface of the exposed portion adjoining the electrically conductive layer has a width greater than that of a side of the exposed portion away from the electrically conductive layer.

7. A method of fabricating a color filter substrate, comprising:
forming a black matrix layer on a transparent substrate layer, and forming, by a photolithography process, a plurality of hollow areas spaced apart from each other on the black matrix layer;
forming a color filter layer on the transparent substrate layer, wherein the color filter layer comprises a plurality of color resists spaced apart from each other and covering the hollow areas of the black matrix layer, respectively, wherein a gap is disposed between adjacent two of the color resists;
forming an electrically conductive layer on the color filter layer;
coating a photoresist layer on the transparent substrate layer to allow part of the photoresist layer to be filled in the gaps of the color filter layer, and another part of the photoresist layer to cover the electrically conductive layer on the color resists; and
forming, by a photolithography process including exposure and development and a baking process, the photoresist layer into a plurality of spacers, wherein a part of each of the spacers is filled up in the gap, and another part is overlapping disposed on the electrically conductive layer corresponding to the color resists.

8. The method of fabricating the color filter substrate of claim 7, wherein the black matrix layer comprises a plurality of photoresist strips disposed in an intersecting arrangement, wherein the plurality of hollow areas are each surrounded by the photoresist strips, and wherein each of the color resists comprises a lip portion overlappingly disposed on the photoresist strips of the black matrix layer.

9. The method of fabricating the color filter substrate of claim 8, wherein a total area of the lip portion of each of the color resists overlapping the photoresist strips is less than a width of a corresponding photoresist strip in cross section.

10. The method of fabricating the color filter substrate of claim 8, wherein the lip portion of each of the color resists is disposed along a periphery of the color resist, and the gap disposed between the adjacent two of the color resists has a width of 5-40 microns.

11. A color filter substrate, adapted to a liquid crystal display panel, the color filter substrate comprising:
a transparent substrate layer;
a black matrix layer disposed on the transparent substrate layer, wherein the black matrix comprises a plurality of photoresist strips disposed in an intersecting arrangement, and a plurality of hollow areas disposed among the photoresist strips;
a color filter layer comprising a plurality of color resists spaced apart from each other and covering the hollow areas of the black matrix layer, respectively, wherein a gap is disposed between adjacent two of the color resists;
an electrically conductive layer disposed on the color filter layer; and
a spacer layer comprising a plurality of spacers, wherein a part of each of the spacers is disposed in the gap of the color filter layer, and another part is overlappingly disposed on the electrically conductive layer corresponding to the color resists;
wherein each of the spacers comprises a root portion and an exposed portion, wherein the root portion is filled up in the gap, the exposed portion is exposed to the gap and is overlappingly disposed on the electrically conductive layer corresponding to the color resists, and a surface of the exposed portion adjoining the electrically conductive layer has a width greater than that of a side of the exposed portion away from the electrically conductive layer.

12. The color filter substrate of claim 11, wherein a total area of the lip portion of each of the color resists overlapping the photoresist strips is less than a width of a corresponding photoresist strip in cross section.

13. The color filter substrate of claim 11, wherein the lip portions of the color resists are fabricated by a halftone mask, and the lip portions each have an inclined edge or a curved edge.

14. The color filter substrate of claim 11, wherein the lip portion of each of the color resists is disposed along a periphery of the color resist, and the gap disposed between the adjacent two of the color resists has a width of 5-40 microns.
